(19) United States
(12) Patent Application Publication
(10) Pub. No.: US 2014/0331944 A1
(43) Pub. Date: Nov. 13, 2014

(54) Multi-Function Dog Leash and Methods of Use

(71) Applicant: John George Chirico, Daly City, CA (US)

(72) Inventor: John George Chirico, Daly City, CA (US)

(21) Appl. No.: 13/889,951

(22) Filed: May 8, 2013

(51) Int. Cl. A01K 27/00

(52) U.S. Cl. CPC A01K 27/003
USPC 119/797

(57) ABSTRACT

An adjustable dog leash and associated obedience training methods are provided. The leash has clamps at opposing ends that can be affixed to a dog collar, belt loops, or other sections of leash. In between the clamps, a cord lock is disposed and engages with two sections of the leash length. When the cord lock is open, it can move freely, along the length, but when it is closed the lengths of the leash portions are temporarily set. A length of leash sectioned off by the cord lock forms an intermediate loop and has n o-ring disposed thereon. End clamps can be secured to the o-ring or the intermediate loop, forming two end loops. Either end loop can be wrapped around the trainer's torso while the other loop is used as a slip lead for a dog. The cord lock configuration reduces the risk of injury-causing leash cinching during training.

### BACKGROUND OF THE INVENTION

1. Field of the Invention

The present invention relates to an animal control device. More specifically, it relates to a dog leash that can be safely wrapped around multiple parts of the human body. Dog trainers and pet owners can maintain control over their dogs without having to user to hold the leash with his or her hands. Methods of training the dog using the leash are also included to facilitate ease of use of the multi-purpose leash.

Dogs have been close companions to human beings for thousands of years. Ever since human groups began to coalesce into villages, cities, wild dogs have patrolled the outskirts of population centers looking for food. Over time, dogs and humans came to accept and even appreciate sharing their space with the other. Humans began to appreciate the dog's guardian abilities, and dogs came to realize that humans can provide a steady supply of food and water. The mutually beneficial relationship has developed into a shared domestic experience with dogs serving as guardians, companions, and even family members.

Despite the development of the affectionate bond between the dog and human being, the relationship is not free from difficulties. Dogs and people require training on how to communicate and co-exist. This often comes in the form of obedience training, socialization, and trial by fire. After proper training, both dog and human can lead happy healthy lives filled with mutual affection.

Obedience training involves practicing small activities repeatedly with a dog, thereby encouraging it to develop an association between the activity and a command. The command may be a spoken word, physical motion, or visual cue. Over time and through repeated practice, the dog begins to perform the activity any time the command is issued. This is a form of submission and acquiescence by the dog and helps to reinforce the hierarchy between owner and pet. Without a proper understanding of its place in the social hierarchy, the dog may act out, destroying furniture, peeing on the rug, and even biting visitors. Thus, it is crucial that obedience training is continued throughout the relationship, to continuously reinforce dominance and good behavior.

A substantial portion of obedience training is performed using a leash to physically tether the dog to the trainer. This prevents the dog from running away during training. Leashes can be used to provide gentle correction to bad behavior, such as a short, sharp tug if the dog barks or growls at an inappropriate time. Though leashes provide a valuable training and restraining tool, they suffer from the drawback that they require the trainer to hold the leash with his or her hands. If the dog is a large breed, it can be extremely difficult for the trainer to hold onto or control the leash when the dog pulls. Wrapping the leash around the body can help solve this problem by giving the trainer greater leverage, however it can also be dangerous, because if the dog pulls too hard, the leash may injure the part of the body to which it is tethered. A hands-free body leash for dog training is needed that is safe for general use and obedience training of large breed dogs.

2. Description of the Prior Art

The present invention is a dog leash that can be wrapped around a trainer's torso, leaving the user's hands free to manage the dog or hold treats. The leash is a single piece length of elastic, shock absorbent cord with spring loaded clasps disposed on opposing ends. A double-headed cord lock engages two sections of the cord creating a loop. End clasps are attached to this intermediate loop to create larger loops that can be fitted over a user's torso, or around the waist. Methods of using the hands free body leash for dogs are described herein. The following list of devices is considered to be relevant to the present disclosure.

Kitchen, U.S. Pat. No. 4,019,463 discloses an animal leash having a slip loop and an adjustable connector disposed along the length of the leash. The leash has an adjustment bracket with holes extending through the bracket. Holes in the leash body align with the adjustment bracket and pins are pushed through the holes to lock the bracket in place. Two sections of leash can be inserted through the bracket and trapped to form a loop handle. In this way, the loop handle size can be adjusted to accommodate the hands of users of varying sizes.

Hong-Rong, U.S. Pat. No. 5,462,019 teaches an animal leash having spring based clamps on either end. A sliding screw vice is disposed along the length of the leash. One clamp can be attached to the screw vice to create a freely sizeable loop. This configuration is not safe because the vice can easily be loosened during use, allowing the vice to slide along the leash length. If the leash is used with a large animal, the animal's strength can result in leash cinching. Without an arresting means, the leash can cinch tightly around the user's arm and cause injury. The present invention solves this problem by providing a double-headed cord lock that reduces the leash's ability to feely adjust during use.

Leon, U.S. Pat. No. 7,013,840 discloses an animal leash that has a pair of screw vices extending through a bracket disposed at one end of the leash. Tone end of the bracket is open to receive the frame of a bicycle. The screw vices are tightened around the inserted bike frame to secure the leash in place. An opposing end of the leash has a clamp that can be secured to a dog's collar. Thus the device can be used to walk a dog while the owner rides a bike. The configuration may be useful for every day exercise of the dog but it is not useful for obedience training because the owner has no control over the animal.

None of these devices describes an arresting means for reducing inadvertent resizing of the leash loop during use. A double-headed cord lock is provided to reduce slippage along the leash length. The configuration of the leash facilitates the formation of three separate loops. An intermediate loop is formed by the portion of the loop sectioned off with the cord lock; first and second loops are formed by joining the end clamps to the intermediate loop. The present invention thus provides structural advances not contemplated by the prior art.

These prior art devices have several known drawbacks. They do not address the safety hazard of leashes that adjust freely in use. The present invention solves this problem by including a cord lock that arrests movement along the length of the leash. It substantially diverges in design elements from the prior art and consequently it is clear that there is a need in the art for an improvement to existing devices. In this regard the instant invention substantially fulfills these needs.

### SUMMARY OF THE INVENTION

In view of the foregoing disadvantages inherent in the known types of adjustable dog leashes now present in the prior art, the present invention provides a new cord lock arresting means wherein the same can be utilized for providing convenience for the user when performing obedience training with a hands free leash.

The present invention is a hands-free dog leash that is length adjustable, and a method for using the leash in obedience training for dogs. A double headed cord lock disposed on the leash length, reduces slippage while the device is worn by a user. This is important because methods of use include creating a first loop that encircles the trainer's torso or waist, and without the anti-slippage mechanism, the leash could cinch, harming the user's body. Additionally, the leash is made from an elastic, shock absorbent cord that extends and then retracts when pulled on by an animal. This self correcting feature is useful in lead walk training and also reduces the likelihood that the trainer will be injured while holding the leash.

A body encircling loop is formed by connecting the first end clamp to the portion of the leash that is sectioned off by the cord lock. This loop is placed around the waist or torso of a user and adjusted as needed. The opposing end clamp is affixed to the collar of a dog in training. Because the trainer's torso is used to prevent the dog from breaking free, the individual is free to use his or her hands to control the dog, reward it, or perform physical command queues. Training techniques, as described herein, may be used to teach the dog without the need for holding onto the leash.

It is therefore an object of the present invention to provide a new and improved adjustable dog leash device that has all of the advantages of the prior art and none of the disadvantages.

It is therefore an object of the present invention to provide a hands free leash that is safe for use with varied parts of the human body.

Another object of the present invention is to provide a leash that can be wrapped around the trainer's torso or waist, to increase stabilization during walking or obedience training.

Yet another object of the present invention is to provide a dog leash that has an adjustable length that can be fixed in any position along the leash length.

Still another object of the present invention is to provide a versatile and easy to use dog leash that can be utilized for a variety of purposes from dog walking to obedience training.

A further object of the present invention, is to provide multiple methods of using the adjustable dog leash described herein during obedience training.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead view of the adjustable dog leash. One end clamp is secured to the intermediate loop to create a first loop that is suitable for placement around a user's torso.

FIG. 2 shows a perspective view of the adjustable dog leash with a first loop created, via a connection between one end clamp and the intermediate loop. The other end clamp is free and unconnected.

FIG. 3 shows a perspective view of the device in use. The first loop is wrapped around a user's torso from shoulder to waist, while the other end is connected to a dog collar.

FIG. 4 shows a close up perspective view of the connection configuration of the dog leash in use.

FIG. 5 shows a perspective view of the adjustable dog leash in use. The first loop encircles the trainer's waist and the second clamp is connected to a dog collar.

### DETAILED DESCRIPTION OF THE INVENTION

Reference is made herein to the attached drawings. Like reference numerals are used throughout the drawings to depict like or similar elements of the adjustable dog leash. For the purposes of presenting a brief and clear description of the present invention, the preferred embodiment will be discussed as used for performing obedience training with dogs. The figures are intended for representative purposes only and should not be considered to be limiting in any respect.

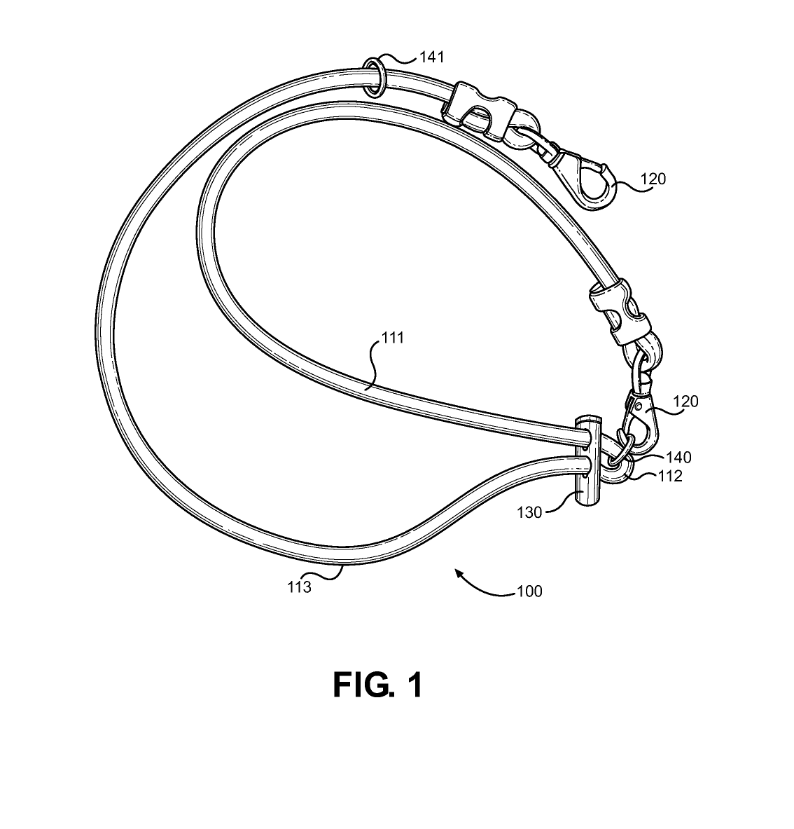

Referring now to FIG. 1, there is shown an adjustable dog leash. The leash 100 is a single piece elongated length of elastic cord. Different types of elastic cord may be used, but the preferred construction is a multi-strand rubber cord having an outer jacket made from an abrasion resistant material such as nylon, polyester or polypropylene. Cords of this nature are preferred due to their highly elastic and shock absorbent nature, which effectively diffuses a portion of the pulling tension when an animal secured to the leash lunges. This construction facilitates both lengthwise elongation and retraction of the cord, which are essential for the self-corrective aspects of leash training. Clamps 120 are disposed on opposing ends of the leash and are used to connect the leash to a dog collar, a trainer, or another leash. Ends of the cord may be formed into small loops by folding the length over on itself and permanently securing the two parts together, with an adhesive, or a fastener. Attaching the clamps to these small end loops provides flexibility of clamp positioning, because they can close along the length of the loop, rather than being permanently affixed in a single position. End clamps may also be spring closure clamps, carabineers, or any other clamp commonly used in animal leashes.

The leash length is separated into a first section b111, an intermediate section 112, and a third section 113 by a cord lock 130.The cord lock has two apertures that encircle portions of the leash length. While the cord lock is loosened, it can slide freely along the leash length, and permit adjustment of different section sizes. But, when the lock is engaged, the cord lock will not move unless subject to great amounts of force. In this way, the leash length is universally sizeable and can maintain a selected size during use. Cord locks are well known in the art and the specific lock used may vary according to manufacturing needs and leash diameter. The type depicted here is a double barrel cord lock with a push closure. Two lengths of leash are inserted through the barrels and the push closure is then depressed to lock them in place. Both double headed and double barreled cord locks are suitable for use with the present invention.

There are multiple o-rings disposed along the leash to provide clamp connection points for the end clamps. A first ring 140 is disposed along the intermediate section 112 to provide an easy clamping location. The second o-ring 141 slides freely along either the first or second section of the leash length. Connecting the end clamps 120 to the rings forms loops from the first or third section. These loops may be used as a body harness, a slip lead, or a collar connector.

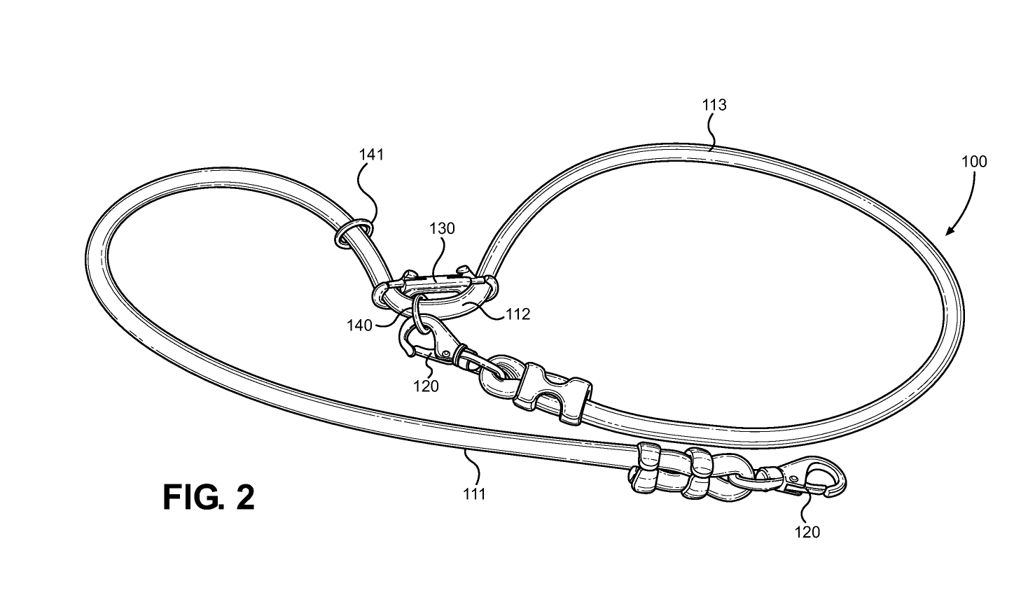

Referring now to FIG. 2, there is shown a second view of the adjustable dog leash. The third section 113 is formed into a loop and an associated end clamp 120 is connected t to the o-ring 140. This o-ring slides freely along the section of the leash length that is sectioned off by the cord lock 130, also known as the intermediate section 112. Conversely, the first section 111 section and its end clamp hang freely, ready for attachment to a dog collar. In this figure, the cord lock is shown as a dual-headed spring closure clamp. This configuration is ideal for smaller dogs and well trained dogs, because the spring closure clamps permit some movement along the leash length and are therefore easily adjustable while in use. Tension placed on the o-ring and intermediate section by an end clamp will reduce slippage during use of the leash, but not to the same extent as the push closure cord locks.

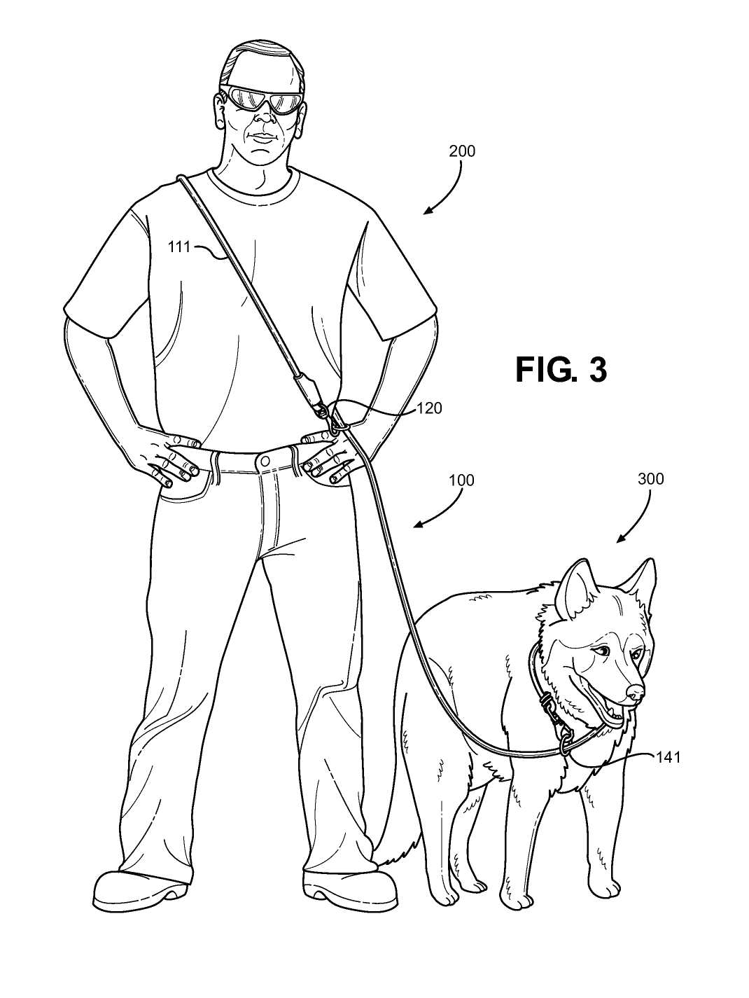

The versatile and freely configurable leash is shown in FIG. 3, in use with a trainer and dog. The trainer 200 has a first section 111 of the leash 100 wrapped around his upper torso. The leash loop extends from the shoulder area down to the waist, in a cross-body placement. Near the waist, the end clamp 120 connects to the o-ring on the intermediate section. A free end of the leash is connected to the collar of a patiently waiting dog 300. The trainer's hands are free to rest o n his hips, reach for treats, pat the dog, or make hand motion command queues because he does not need to hold the leash in order to maintain control over the animal. The leash is removably secure to the animal's neck via a slip lead configuration. This configuration is formed by attaching the end clamp distal from the trainer to the freely sliding second o-ring 141 to form a size adjustable loop that is placed around the dog's neck. To ensure animal safety, the loop should be placed along the line of connection between the neck and head, where it cannot constrict around the animal's windpipe.

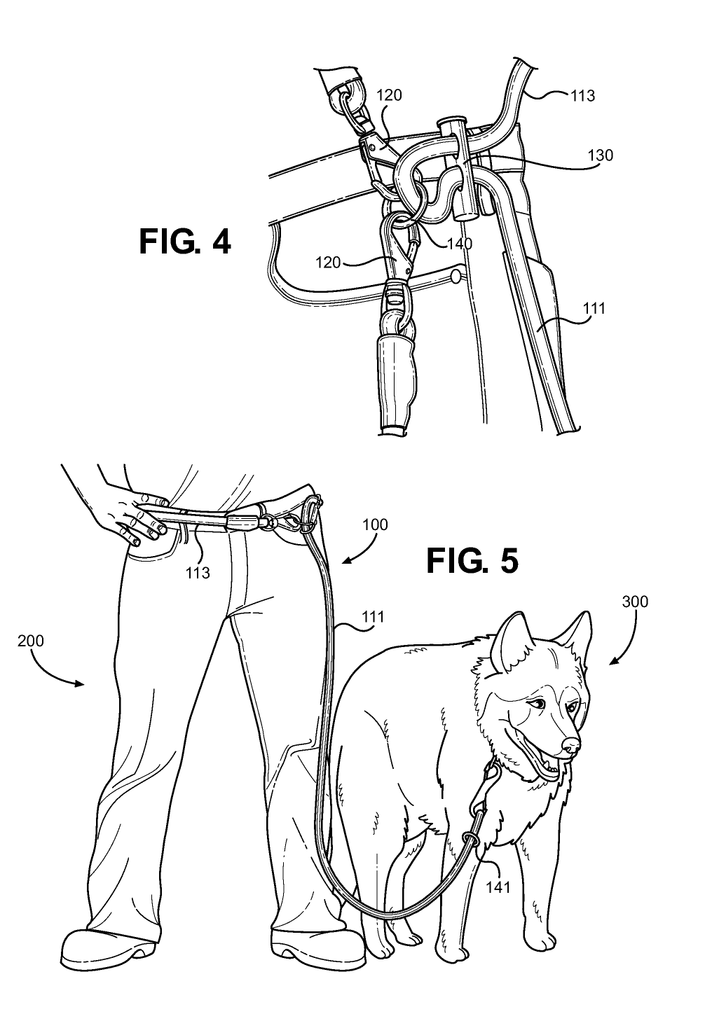

An exploded view of the connection configuration is shown in FIG. 4. The third section 113 is looped around a portion of the user's upper body and connects to the intermediate section 112. The end clamp 120 is connected to the intermediate section o-ring 140. A lower loop formed via the first section 111 hangs down from the user's waist area. The second end clamp is also connected to the o-ring, but alternatively may be connected to the intermediate section itself. A cord lock 130 divides the leash length into three sections and reduces re-sizing while the leash is in place.

Another way of wearing the leash is shown in FIG. 5. The dog leash 100 encircles the waist of a trainer 200 rather than the upper torso. This configuration is particularly well suited for animals who are well behaved and do not need to remain close to the trainer. A smaller loop is formed around the user's waist than the upper torso, thus leaving more of the leash length between the trainer and dog 300. This configuration works well for daily walks with an obedient dog. As with the upper torso style of wear, the third section 113 encircles a portion of the user's body and the first section 111 is connected to a dog collar. Alternatively, the first section (or third) may be formed into a slip lead dog collar by affixing the clamp to the leash length to form a cinching collar.

There are three obedience training techniques utilizing the adjustable dog leash described herein. One method is directed towards house-breaking a puppy, and two are directed towards methods of walking a dog.

To teach a puppy not to eliminate his bladder or bowels inside the house, a pet owner must repeatedly take the puppy an appropriate outside elimination area. Because puppies lack bladder control and can eliminate with little to no warning, this must be done frequently. A flat collar is placed around the puppy's neck so that the present leash invention can be easily attached if the puppy starts eliminate indoors. When this happens, the owner should attach the adjustable dog leash to his or her waist, in a waist loop and attach the free end to the puppy's collar. The owner immediately walks with the leashed puppy or carries the puppy outside to a predetermined elimination area. Once the appropriate spot is reached, the owner stands in the area, acting as a center pole that the puppy can walk around while looking for a place to use the restroom. The umbilical tether created by the leash prevents the puppy from wandering away from the predetermined elimination area. Though the over the shoulder configuration may be used for this exercise, the hip harness configuration is preferred because it provides the puppy with greater freedom of movement within the selected area. The present invention is a substantial improvement over standard leashes because it does not require the use of a person's hands, leaving them free to hold treats and clean-up bags. Each successful elimination by the puppy is rewarded with high value treats and praise. Positive reinforcement is an essential component of teaching the puppy the proper elimination process. Each trip outdoors should visit the same elimination area to create an association in the puppy's mind between the outdoors and using the bathroom. The procedure should be repeated every sixty to ninety minutes. At times of high elimination risk, such as before sleep, after waking up, or after the puppy eats, the procedure should be repeated every fifteen minutes until the puppy eliminates outdoors. Regular repetition of this procedure at predictable time intervals will quickly result in the “housebreaking” of the puppy and a slowly extending time frame between trips to the elimination area.

The present invention is ideal for teaching dogs to walk on a leash, and a training walk technique for this instruction is provided. Walking the dog by the trainer or owner's side is important because it establishes dominance within a social hierarchy. The earlier the dog learns the walk with a leash, the better it will understand its position in the family hierarchy. To begin the process the trainer forms a slip lead on one end of the leash by connecting the end clamp to the leash length. This loop is placed around the base of the dog's neck to avoid harming the dog. The cord lock is moved into position behind the end clamp connection the he lead and locked into place. This helps maintain a snug fit around the dog's neck but prevents the loop from cinching too tightly or becoming so loose that it falls off. The free end of the leash is formed into a loop that the trainer can use as a handle. Once the leash is in place, the trainer begins to walk. If the dog pulls, the trainer performs a short tug on the leash to correct the dog's behavior. At all times, the dog should be kept by the trainer's side and not allowed to run off in his own direction. This process is repeated for each walk until the dog learns to walk on a leash without pulling.

Lastly, the present invention provides for a loose lead walk technique for dogs of all sizes. This technique allows for more freedom of range on a leash, while teaching the dog not to pull. The leash is first attached to the dog's collar using one of the leash end clamps. The other end clamp is wrapped around the trainer's torso and secured to the o-ring of the intermediate section, forming a body loop. This body loop is placed around the trainer's upper torso or waist and secured in size by moving the cord lock into position near the waist. Next, the trainer begins the walk, letting the dog walk in front or to the side, so long as it does not pull. If the dog pulls, the trainer ceases motion and uses one or both hands to execute a command motion for the dog to return to the trainer's side. Commands may include slapping the thigh, whistling, stating a predetermined command word, or the like. The present invention's elastic and shock absorbent properties provide a self-correcting feature by retracting after a dog lunges or tries to run. Though the dog may lunge forward during the walk, the leash will stretch in length during the lunging motion then automatically retract back to its resting length, thereby pulling the dog backward. If the dog refuses to return to the correct position despite the command and the auto-correction feature, the trainer walks backwards, and then uses his hands to re-orient the dog at his side. Once the dog's position is reset it should be praised and rewarded at which point, the walk can continues.

The present invention is a freely adjustable, elastic safety leash for dog obedience training. A number of configurations are possible with the leash and each is useful for particular types of obedience training. Most configurations of the leash leave the user's hands free to carry items, pet the dog, or swing freely. This provides the user with freedom of movement while still allowing them to maintain control over the dog. A cord lock is adjustably disposed along the length of the leash and can move from a first end to a second end without impediment. The cord lock separates the leash into three re-sizeable sections. When the cord lock is in a locked position, the sections cannot be resized, thus preventing them from inadvertent cinching during use. In this manner, the present invention reduces the risk of injury associated with walking large or strong dogs.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An adjustable dog leash, comprising:
a single, elastic elongated length having a first and second end;
a clamp disposed a said first end and said second end of said leash;
a cord lock having two leash accepting apertures adjustably disposed along said leash length, wherein said cord lock can be moved from said first end to said second end of said leash without impediment, and wherein said cord lock divides said leash length into a first section an intermediate section and a third section;
a first ring loosely disposed along said intermediate section;
a second ring freely slideable along one of said first or third sections.

2) The device of claim 1, wherein said cord lock is a double barrel cord lock.

3) The device of claim 1, wherein said cord lock is a double headed spring closure clamp.

4) The device of claim 1 wherein said first and second rings are o-rings.

5) The device of claim 1, wherein said end clamps are carabineers.

6) The device of claim 1, wherein said intermediate section terminates on either end at a leash accepting aperture of said cord lock.

7) The device of claim 1, wherein said first section and said third section begin at a respective end clamp and terminate at a leash accepting aperture of said cord lock.

8) A method of housebreaking a dog using a universally adjustable dog leash having a cord lock, comprising the steps of:
initiating an outdoor elimination session at predetermined time intervals;
wrapping a first section of an adjustable dog leash into a loop and connecting an end clamp of said leash to a first ring disposed along a portion of said dog leash sectioned off via cord lock, wherein said loop encircles a user's waist when in use;
adjusting the positioning of said cord lock disposed on said leash length to reduce the diameter of said loop;
locking said cord lock, thereby reducing its ability to move along said dog leash;
hooking an opposing end clamp to a dog collar, wherein said dog collar is removably fastened around a dog's neck when in use;
moving said leash to a predetermined elimination location outside of a dwelling;
remaining in said elimination location for a second predetermined interval;
providing praise upon elimination by a dog.

9) The method of claim 8 wherein said predetermined interval is one hour.

10) A method of training a dog to walk using an adjustable dog leash having a cord lock, comprising the steps of:
forming a slip loop by affixing an end clamp to a freely slideable second ring disposed along a portion of a leash body, wherein said slip loop fits around an upper portion of a dog's neck when in use;
positioning a cord lock disposed along said leash body above said slip loop;
locking said cord lock, thereby reducing its ability to move along said leash body;
forming a handle loop from an opposing end of said leash wherein said handle loop is placed around a trainer's hand when in use;
moving forward until a forward pulling motion is exerted on said slip loop;
tugging sharply on a portion of said leash body repeatedly until said forward pulling motion ceases.

11) The method of claim 10, wherein said second end clamp is affixed to said slip loop.

12) A method of walking a dog using an adjustable leash having a cord lock, comprising the steps of:
wrapping a first section of an adjustable dog leash into a body loop and connecting an end clamp of said leash to a ring disposed along a portion of said dog leash sectioned of via a cord lock, wherein said loop encircles a portion of a user's torso when in use;
adjusting the positioning of said cord lock disposed on said leash length to reduce the diameter of said loop;
locking said cord lock, thereby reducing its ability to move along said dog leash;
hooking an opposing end clamp to a dog collar, wherein said dog collar is removably fastened around a dog's neck when in use;
walking forward until a forward pulling motion is exerted on said dog collar;
executing a command;
walking backward until retroactive force is exerted on said leash;
repeating said command execution and moving backward steps until a the dog walks backward.

13) The method of claim 12, wherein said command is a hand gesture.

14) The method of claim 12, wherein said command is an oral statement.
